(19) United States
(12) Patent Application Publication
(10) Pub. No.: US 2025/0039756 A1
(43) Pub. Date: Jan. 30, 2025

(54) METHOD AND APPARATUS FOR CONDITIONAL RECONFIGURATION OF USER EQUIPMENT AND BASE STATION IN WIRELESS COMMUNICATION SYSTEM

(71) Applicant: Samsung Electronics Co., Ltd., Gyeonggi-do (KR)

(72) Inventor: June HWANG, Gyeonggi-do (KR)

(21) Appl. No.: 18/786,087

(22) Filed: Jul. 26, 2024

(30) Foreign Application Priority Data
Jul. 26, 2023 (KR) 10-2023-0097752

(51) Int. Cl. H04W 36/26; H04W 28/086; H04W 48/18

(52) U.S. Cl. CPC H04W 36/26; H04W 28/0861; H04W 48/18

(57) ABSTRACT

The disclosure relates to a 5G or 6G communication system for supporting a higher data transmission rate. A method performed by a terminal in a wireless communication system includes obtaining a first type of conditional reconfiguration and a second type of conditional reconfiguration, identifying whether at least one condition associated with the first type of conditional reconfiguration and the second type of conditional reconfiguration is fulfilled, wherein in case that a condition for a primary cell (PCell) associated with the first type of conditional reconfiguration is fulfilled, the PCell associated with the first type of conditional reconfiguration is identified as a triggered cell, and in case that conditions for a PCell and a primary secondary cell group cell (PSCell) associated with the second type of conditional reconfiguration are fulfilled, the PCell and the PSCell associated with the second type of conditional reconfiguration are identified as a pair of triggered cells, identifying whether one or more pairs of triggered cells exist, in case that the one or more pairs of triggered cells do not exist, identifying whether one or more triggered cells exist, and in case that the one or more triggered cells exist, applying the first type of conditional reconfiguration.

### CROSS-REFERENCE TO RELATED APPLICATION(S)

This application is based on and claims priority under 35 U.S.C. § 119 to Korean Patent Application No. 10-2023-0097752, filed on Jul. 26, 2023, in the Korean Intellectual Property Office, the disclosure of which is incorporated herein by reference in its entirety.

### BACKGROUND

### 1. Field

The disclosure relates generally to a wireless communication system, and more particularly, to a method and an apparatus for a conditional reconfiguration of a user equipment (UE) and a base station in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Development of wireless communication systems has made it possible to provide various services, and a scheme for effectively providing such services is accordingly required. Particularly, there is a need in the art for a scheme for reducing the delay time in connection with performing a conditional reconfiguration such as a conditional handover, a conditional primary secondary cell group (PSCell) addition (CPA), and/or a conditional PSCell change (PCP) in a wireless communication system.

### SUMMARY

The disclosure has been made to address at least the above-mentioned problems and/or disadvantages and to provide at least the advantages described below.

Accordingly, an aspect of the disclosure is to provide a method and apparatus by which the delay time may be reduced effectively in connection with performing a conditional reconfiguration such as a conditional handover, a conditional PSCell addition, and/or a conditional PSCell change in a wireless communication system.

In accordance with an aspect of the disclosure, a method performed by a terminal in a wireless communication system includes obtaining a first type of conditional reconfiguration and a second type of conditional reconfiguration, identifying whether at least one condition associated with the first type of conditional reconfiguration and the second type of conditional reconfiguration is fulfilled, wherein in case that a condition for a primary cell (PCell) associated with the first type of conditional reconfiguration is fulfilled, the PCell associated with the first type of conditional reconfiguration is identified as a triggered cell, and in case that conditions for a PCell and a primary secondary cell group cell (PSCell) associated with the second type of conditional reconfiguration are fulfilled, the PCell and the PSCell associated with the second type of conditional reconfiguration are identified as a pair of triggered cells, identifying whether one or more pairs of triggered cells exist, in case that the one or more pairs of triggered cells do not exist, identifying whether one or more triggered cells exist, and in case that the one or more triggered cells exist, applying the first type of conditional reconfiguration.

In accordance with an aspect of the disclosure, a terminal in a wireless communication system includes a transceiver, and a controller coupled with the transceiver and configured to obtain a first type of conditional reconfiguration and a second type of conditional reconfiguration, identify whether at least one condition associated with the first type of conditional reconfiguration and the second type of conditional reconfiguration is fulfilled, wherein in case that a condition for a PCell associated with the first type of conditional reconfiguration is fulfilled, the PCell associated with the first type of conditional reconfiguration is identified as a triggered cell, and in case that conditions for a PCell and a PSCell associated with the second type of conditional reconfiguration are fulfilled, the PCell and the PSCell associated with the second type of conditional reconfiguration are identified as a pair of triggered cells, identify whether one or more pairs of triggered cells exist, in case that the one or more pairs of triggered cells do not exist, identify whether one or more triggered cells exist, and in case that the one or more triggered cells exist, apply the first type of conditional reconfiguration.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a long term evolution (LTE) system according to an embodiment;

FIG. 2 illustrates a radio protocol structure of an LTE system according to an embodiment;

FIG. 3 illustrates a structure of a next-generation mobile communication system according to an embodiment;

FIG. 4 illustrates a radio protocol structure of a next-generation mobile communication system according to an embodiment;

FIG. 5 is a block diagram illustrating the structure of a UE according to an embodiment;

FIG. 6 is a block diagram illustrating the structure of a base station according to an embodiment;

FIG. 7 illustrates an example of a conditional handover (CHO) configuration and a conditional handover plus conditional PSCell addition or change (CHO+CPAC) configuration according to an embodiment;

FIG. 8 is a flowchart illustrating operations of a UE according to an embodiment;

FIG. 9 illustrates an example of a CHO configuration and a CHO+CPAC configuration of each time interval according to an embodiment;

FIG. 10 illustrates operations of a UE in which a CHO+CPAC configuration is applied preferentially according to an embodiment; and

FIG. 11 illustrates operations of a UE in which a CHO configuration is applied preferentially according to an embodiment.

### DETAILED DESCRIPTION

Hereinafter, embodiments of the disclosure will be described in detail with reference to the accompanying drawings. It should be noted that in the drawings, the same or similar elements are preferably denoted by the same or similar reference numerals. Detailed descriptions of known functions or configurations that may make the subject matter of the disclosure unclear will be omitted for the sake of clarity and conciseness.

The terms which will be described below are defined in consideration of the functions in the disclosure, and may be different according to users, intentions of the users, or customs. Therefore, the definitions of the terms should be made based on the contents throughout the specification.

Herein, terms for identifying access nodes and referring to network entities, messages, interfaces between network entities, and various identification information are illustratively used for the sake of descriptive convenience. Therefore, the disclosure is not limited by the terms as described below, and other terms referring to subjects having equivalent technical meanings may also be used.

In the following description, a base station is an entity that allocates resources to terminals, and may be at least one of a gNode B, an eNode B, a Node B, a base station (BS), a wireless access unit, a base station controller, and a node on a network. A terminal may include a UE, a mobile station (MS), a cellular phone, a smartphone, a computer, or a multimedia system capable of performing a communication function. A downlink (DL) refers to a radio link via which a base station transmits a signal to a terminal, and an uplink (UL) refers to a radio link via which a terminal transmits a signal to a base station. Herein, LTE or LTE-A systems may be described by way of example, but the embodiments may also be applied to other communication systems having similar technical backgrounds or channel types. Examples of such communication systems may include 5G and NR developed beyond LTE-A. 5G may be the concept that covers the exiting LTE, LTE-A, or other similar services. The disclosure may also be applied to other communication systems through some modifications without significantly departing from the scope of the disclosure.

Herein, an element is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

In the following description, terms and names defined in 5 GS and NR standards specified by the 3rd generation partnership project (3GPP) group among the existing communication standards, will be used for the sake of descriptive convenience. However, the disclosure is not limited by these terms and names and may be applied in the same manner to systems that conform to other standards, such as the 5th generation mobile communication standards.

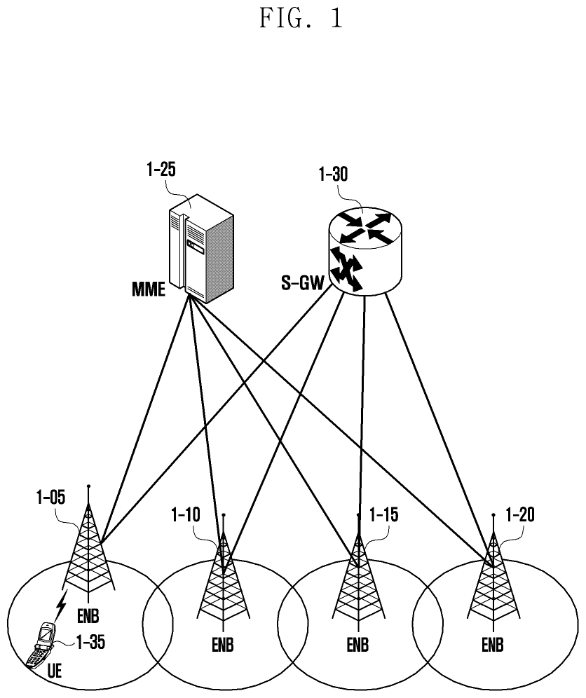

FIG. 1 illustrates a structure of an LTE system according to an embodiment.

Referring to FIG. 1, a radio access network of an LTE system may include next-generation base stations (evolved node Bs (ENBs), node Bs, or base stations) 1-05, 1-10, 1-15, and 1-20, a mobility management entity (MME) 1-25, and a serving gateway (S-GW) 1-30. AUE or terminal 1-35 may access an external network through the ENBs 1-05 to 1-20 and the S-GW 1-30.

In FIG. 1, each of the ENBs 1-05 to 1-20 may correspond to a conventional node B in a universal mobile telecommunications service (UMTS) system. The ENBs may be connected to the UE 1-35 through a radio channel, and perform more complicated roles than the conventional node Bs. In the LTE system, since all user traffic including real-time services, such as voice over Internet protocol (VoIP), may be serviced through a shared channel. Thus, a device that collects state information, such as buffer states, available transmit power states, and channel states of UEs, and performs scheduling accordingly is required, and the ENBs 1-05 to 1-20 may serve as the device. In general, one ENB may control multiple cells. For example, to implement a transfer rate of 100 megabits per second (Mbps), the LTE system may use orthogonal frequency division multiplexing (OFDM) as a radio access technology in a bandwidth of, for example, 20 MHz. The LTE system may employ an adaptive modulation & coding (AMC) scheme for determining a modulation scheme and a channel coding rate according to a channel state of a UE. The S-GW 1-30 provides a data bearer and may generate or remove a data bearer under the control of the MME 1-25. The MME is responsible for various control functions as well as a mobility management function for a UE and may be connected to multiple base stations.

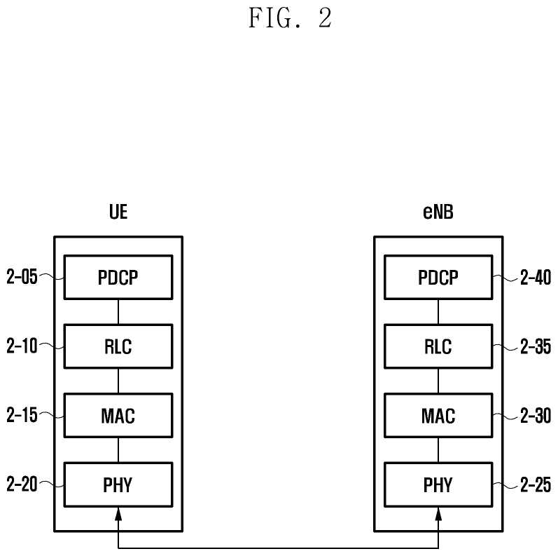

FIG. 2 illustrates a radio protocol structure of an LTE system according to an embodiment.

Referring to FIG. 2, a radio protocol of an LTE system may include a packet data convergence protocol (PDCP) 2-05 or 2-40, a radio link control (RLC) 2-10 or 2-35, and a medium access control (MAC) 2-15 or 2-30 on each of UE and eNB sides. The PDCP 2-05 or 2-40 may serve to perform operations such as IP header compression/reconstruction. The main functions of the PDCP 2-05 or 2-40 may be summarized as follows.
Robust header compression (ROHC) and decompression
Transfer of user data
In-sequence delivery of upper layer protocol data units (PDUs) at PDCP re-establishment procedure for RLC AM
For split bearers in DC for RLC AM: PDCP PDU routing for transmission and PDCP PDU reordering for reception
Duplicate detection of lower layer SDUs at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink
The RLC 2-10 or 2-35 may reconfigure a PDCP PDU into an appropriate size to perform an ARQ operation. The main functions of the RLC may be summarized as follows.
Transfer of upper layer PDUs
Error Correction through ARQ for AM data transfer
Concatenation, segmentation and reassembly of RLC SDUs for UM and AM data transfer
Re-segmentation of RLC data PDUs for AM data transfer
Reordering of RLC data PDUs for UM and AM data transfer
Duplicate detection for UM and AM data transfer
Protocol error detection for AM data transfer
RLC SDU discard for UM and AM data transfer
RLC re-establishment

The MAC 2-15 or 2-30 may be connected to several RLC layer devices configured in a single terminal, and multiplex RLC PDUs into a MAC PDU and demultiplex a MAC PDU into RLC PDUs. The main functions of the MAC 2-15 or 2-30 are summarized as follows.
Mapping between logical channels and transport channels
Multiplexing/demultiplexing of MAC SDUs belonging to one or different logical channels into/from transport blocks (TBs) delivered to/from the physical layer on transport channels
Scheduling information reporting
Error correction through HARQ
Priority handling between logical channels of one UE
Priority handling between UEs by means of dynamic scheduling
Multimedia broadcast multicast service (MBMS) service identification
Transport format selection
Padding

A physical (PHY) layer 2-20 or 2-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

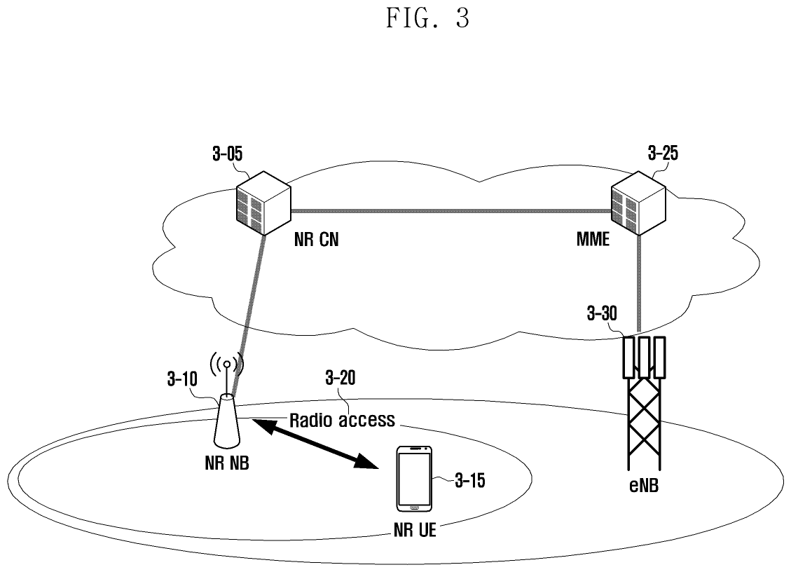

FIG. 3 illustrates a structure of a next-generation mobile communication system according to an embodiment.

Referring to FIG. 3, a radio access network of a next-generation mobile communication system may include an NR gNB or NR base station 3-10, and a new radio core network (NR CN) 3-05. An NR UE or NR terminal 3-15 may access an external network via the NR gNB 3-10 and the NR CN 3-05 through a radio access 3-20 link.

In FIG. 3, the NR gNB 3-10 may correspond to an eNB of a conventional LTE system. The NR gNB may be connected to the NR UE 3-15 through a radio channel and provide improved services as compared to a conventional node B. In the next-generation mobile communication system, since all user traffic may be serviced through a shared channel. Thus, a device that collects state information, such as buffer states, available transmit power states, and channel states of UEs, and performs scheduling accordingly is required, and the NR gNB 3-10 may be responsible for the scheduling.

In general, one NR gNB may control multiple cells. To implement ultrahigh-speed data transfer beyond the current LTE, the next-generation mobile communication system may provide a wider bandwidth than the existing maximum bandwidth, may employ OFDM as a radio access technology, may additionally integrate a beamforming technology therewith, and may employ an AMC scheme for determining a modulation scheme and a channel coding rate according to a channel state of a UE. The NR CN 3-05 may perform functions such as mobility support, bearer configuration, and quality of service (QoS) configuration, is responsible for various control functions as well as a mobility management function for a UE and may be connected to multiple base stations. The next-generation mobile communication system may interwork with the existing LTE system, and the NR CN may be connected to an MME 3-25 via a network interface. The MME may be connected to an eNB 3-30 that is an LTE base station.

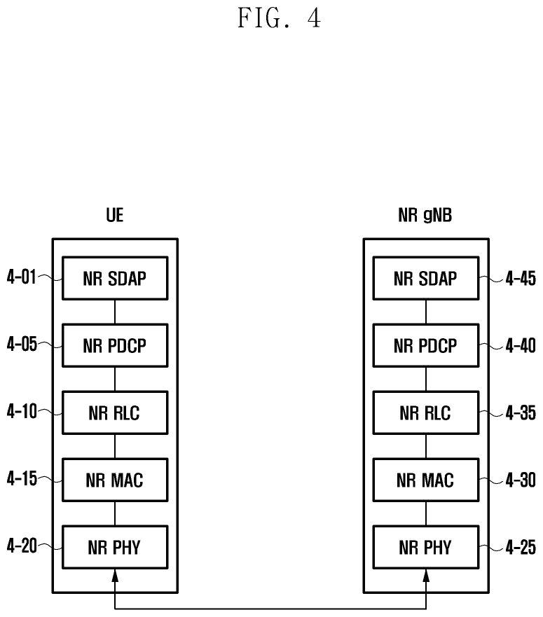

FIG. 4 illustrates a radio protocol structure of a next-generation mobile communication system according to an embodiment.

Referring to FIG. 4, a radio protocol of a next-generation mobile communication system may include an NR service data adaptation protocol (SDAP) 4-01 or 4-45, an NR PDCP 4-05 or 4-40, an NR RLC 4-10 or 4-35, an NR MAC 4-15 or 4-30, and an NR PHY 4-20 or 4-25 on each of UE and NR base station sides.

The main functions of the NR SDAP 4-01 or 4-45 may include transfer of user plane data, mapping between a QoS flow and a DRB for both DL and UL, marking QoS flow ID in both DL and UL packets, and reflective QoS flow to DRB mapping for UL SDAP PDUs.

Whether to use the header of the SDAP layer device or functions of the SDAP layer device may be configured for the UE through an RRC message according to PDCP layer devices, bearers, or logical channels. If an SDAP header is configured, the non-access stratum (NAS) QoS reflection configuration 1-bit indicator (NAS reflective QoS) of the SDAP header and the access stratum (AS) QoS reflection configuration 1-bit indicator (AS reflective QoS) may indicate, to the UE, that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP 4-05 or 4-40 may include some of functions below.
ROHC and decompression
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

Among the above-described functions, the reordering of the NR PDCP device may refer to reordering PDCP PDU received from a lower layer in an order based on PDCP sequence numbers. The reordering of the NR PDCP device may include transferring data to an upper layer according to a rearranged order, may include directly transferring data without considering order, may include rearranging order to record lost PDCP PDUs, may include reporting the state of lost PDCP PDUs to a transmission side, and may include requesting retransmission of lost PDCP PDUs.

The main functions of the NR RLC 4-10 or 4-35 may include some of the following functions.
Transfer of upper layer PDUs
In-sequence delivery of upper layer PDUs
Out-of-sequence delivery of upper layer PDUs
Error correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

Among the above-described functions, the in-sequence delivery of the NR RLC device may refer to delivering RLC SDUs, received from the lower layer, to the upper layer in sequence. If one original RLC SDU is divided into several RLC SDUs and the RLC SDUs are received, the in-sequence delivery function of the NR RLC device may include reassembling the several RLC SDUs and transferring the reassembled RLC SDUs.

The in-sequence delivery function of the NR RLC device may include rearranging received RLC PDUs with reference to RLC SNs or PDCP sequence numbers, may include rearranging order to record lost RLC PDUs, may include reporting the state of lost RLC PDUs to a transmission side, and may include requesting retransmission of lost RLC PDUs.

The in-sequence delivery of the NR RLC device may include, if there is a lost RLC PDU, delivering only RLC SDUs before the lost RLC PDU to the upper layer in sequence.

The in-sequence delivery of the NR RLC device may include, although there is a lost RLC SDU, if a predetermined timer has expired, sequentially transferring, to the upper layer, all the RLC SDUs received before the timer is started.

The in-sequence delivery of the NR RLC device may include, although there is a lost RLC SDU, if a predetermined timer has expired, sequentially transferring all the RLC SDUs received up to the present time, to the upper layer.

The NR RLC device may process RLC PDUs in a reception sequence, regardless of a sequence based on sequence numbers (out-of-sequence delivery). and then deliver the processed RLC PDUs to the NR PDCP device.

If receiving segments, the NR RLC device may receive segments stored in a buffer or to be received in the future, reconfigure the segments into one whole RLC PDU, process the RLC PDU, and then deliver the processed RLC PDU to the NR PDCP device.

The NR RLC layer may not include the concatenation function, which may be performed in the NR MAC layer or replaced with a multiplexing function of the NR MAC layer.

Among the above-described functions, the out-of-sequence delivery of the NR RLC device may refer to instantly delivering RLC SDUs received from the lower layer to the upper layer regardless of the order. The out-sequence delivery of the NR RLC device may include, if one original RLC SDU is segmented into multiple RLC SDUs and the segmented RLC SDUs are received, reassembling the RLC SDUs and delivering the reassembled RLC SDUs. The out-of-sequence delivery function of the NR RLC device may include storing RLC or PDCP sequence numbers of received RLC PDUs and arranging the order thereof to record lost RLC PDUs.

The NR MAC 14-15 or 4-30 may be connected to multiple NR RLC layer devices configured in one UE, and the main functions of the NR MAC may include some of the following functions.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

The NR PHY layer 4-20 or 4-25 may perform operations of channel-coding and modulating upper layer data, thereby obtaining OFDM symbols, and delivering the OFDM symbols through a radio channel, or demodulating OFDM symbols received through the radio channel, and channel-decoding and delivering the OFDM symbols to the upper layer.

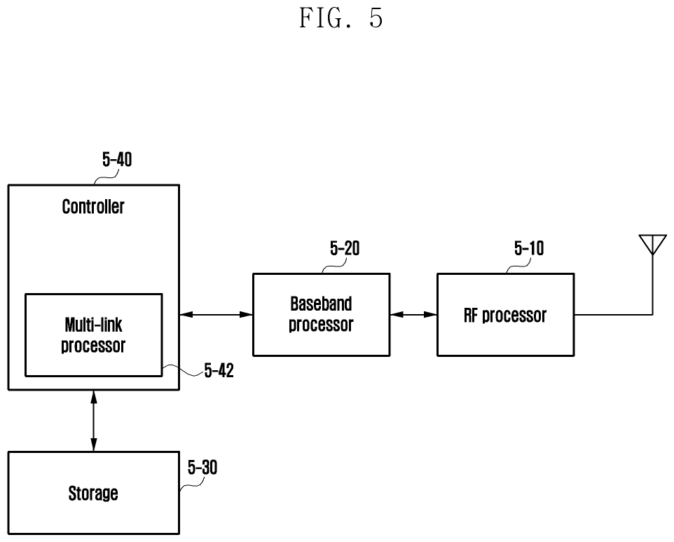

FIG. 5 is a block diagram illustrating the structure of a UE according to an embodiment.

Referring to FIG. 5, the UE includes a radio frequency (RF) processing unit 5-10, a baseband processing unit 5-20, a storage unit 5-30, and a controller 5-40. The controller 5-40 may include a multi-link processor 5-42.

The RF processing unit 5-10 performs functions for transmitting/receiving signals through a radio channel, such as signal band conversion and amplification. The RF processing unit 5-10 up-converts a baseband signal provided from the baseband processing unit 5-20 to an RF band signal, transmits the same through an antenna, and down-converts an RF band signal received through the antenna to a baseband signal. For example, the RF processing unit 5-10 may include a transmission filter, a reception filter, an amplifier, a mixer, an oscillator, a digital-to-analog converter (DAC), and an analog-to-digital converter (ADC) and the like. Although only one antenna is illustrated in FIG. 5, the UE may include multiple antennas. The RF processing unit 5-10 may include multiple RF chains and may perform beamforming. For the beamforming, the RF processing unit 5-10 may adjust the phase and magnitude of signals transmitted/received through multiple antennas or antenna elements, respectively. The RF processing unit 5-10 may perform MIMO and may receive multiple layers when performing a MIMO operation.

The baseband processing unit 5-20 performs functions of conversion between baseband signals and bitstrings according to the system's physical layer specifications. For example, during data transmission, the baseband processing unit 5-20 encodes and modulates a transmitted bitstring to generate complex symbols. During data reception, the baseband processing unit 5-20 demodulates and decodes a baseband signal provided from the RF processing unit 5-10 to restore a received bitstring. For example, when following the OFDM scheme, during data transmission, the baseband processing unit 5-20 encodes and modulates a transmitted bitstring to generate complex symbols, maps the complex symbols to subcarriers, and configures OFDM symbols through inverse fast Fourier transform (IFFT) operation and cyclic prefix (CP) insertion. During data reception, the baseband processing unit 5-20 splits a baseband signal provided from the RF processing unit 5-10 at the OFDM symbol level, restores signals mapped to subcarriers through fast Fourier transform (FFT), and restores a received bitstring through demodulation and decoding.

The baseband processing unit 5-20 and the RF processing unit 5-10 transmit and receive signals as described above and may be referred to as a transmitter, a receiver, a transceiver, or a communication unit. At least one of the baseband processing unit 5-20 and the RF processing unit 5-10 may include multiple communication modules to support multiple different radio access technologies. At least one of the baseband processing unit 5-20 and the RF processing unit 5-10 may include different communication modules to process signals in different frequency bands. For example, the different radio access technologies may include a wireless local area network (LAN), a cellular network such as LTE, and the like. The different frequency bands may include a super high frequency (SHF) (for example, 2.NRHz, NRhz) bands and mmWave (for example, 60 GHz) bands.

The storage unit 5-30 stores data such as basic programs for operations of the UE, application programs, and configuration information, such as information related to a second access node which performs radio communication by using a second radio access technology. The storage unit 5-30 provides the stored data at the request of the controller 5-40.

The controller 5-40 controls overall operations of the UE. For example, the controller 5-40 transmits/receives signals through the baseband processing unit 5-20 and the RF processing unit 5-10T and records and reads data in the storage unit 5-40. To this end, the controller 5-40 may include at least one processor. For example, the controller 5-40 may include a communication processor (CP) configured to perform control for communication, and an application processor (AP) configured to control upper layers such as application programs.

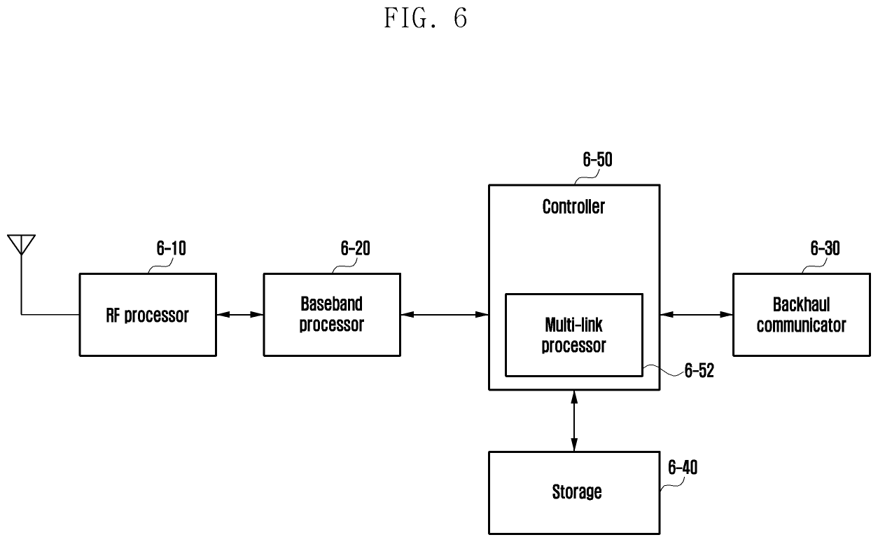

FIG. 6 is a block diagram illustrating the structure of a base station according to an embodiment.

Referring to FIG. 6, the base station includes an RF processing unit 6-10, a baseband processing unit 6-20, a backhaul communication unit 6-30, a storage unit 6-40, and a controller 6-50. The controller 6-50 may include a multi-link processor 6-52.

The RF processing unit 6-10 performs functions for transmitting/receiving signals through a radio channel, such as signal band conversion and amplification. The RF processing unit 6-10 up-converts a baseband signal provided from the baseband processing unit 6-20 to an RF band signal, transmits the signal through an antenna, and down-converts an RF band signal received through the antenna to a baseband signal. For example, the RF processing unit 6-10 may include a transmission filter, a reception filter, an amplifier, a mixer, an oscillator, a DAC, and an ADC. Although only one antenna is illustrated in FIG. 6, the first access node may include multiple antennas. The RF processing unit 6-10 may include multiple RF chains and may perform beamforming. For the beamforming, the RF processing unit 6-10 may adjust the phase and magnitude of signals transmitted/received through multiple antennas or antenna elements, respectively. The RF processing unit may transmit one or more layers to perform a downward MIMO operation.

The baseband processing unit 6-20 performs functions of conversion between baseband signals and bitstrings according to the physical layer specifications of first radio access technology. For example, during data transmission, the baseband processing unit 6-20 encodes and modulates a transmitted bitstring to generate complex symbols. During data reception, the baseband processing unit 6-20 demodulates and decodes a baseband signal provided from the RF processing unit 6-10 to restore a received bitstring. When following the OFDM scheme, during data transmission, the baseband processing unit 6-20 encodes and modulates a transmitted bitstring to generate complex symbols, maps the complex symbols to subcarriers, and configures OFDM symbols through IFFT operation and CP insertion. During data reception, the baseband processing unit 6-20 splits a baseband signal provided from the RF processing unit 6-10 at the OFDM symbol level, restores signals mapped to subcarriers through FFT operation, and restores a received bitstring through demodulation and decoding. The baseband processing unit 6-20 and the RF processing unit 6-10 transmit and receive signals as described above. Therefore, the baseband processing unit 6-20 and the RF processing unit 6-10 may be referred to as a transmitter, a receiver, a transceiver, a communication unit, or a wireless communication unit.

The backhaul communication unit 6-30 provides an interface for communicating with other nodes in the network. The backhaul communication unit 6-30 converts a bitstring transmitted from the main base station to another node, such as an auxiliary base station, a core network or the like, to a physical signal, and converts a physical signal received from the other node to a bitstring.

The storage unit 6-40 stores data such as basic programs for operations of the main base station, application programs, and configuration information. Particularly, the storage unit 6-40 may store information regarding a bearer allocated to a connected UE, a measurement result reported from the connected UE, and the like. The storage unit 6-40 may store information serving as a criterion to determine whether to provide or suspend multi-connection to a UE. The storage unit 6-40 provides the stored data at the request of the controller 6-50.

The controller 6-50 controls overall operations of the base station. For example, the controller 6-50 transmits/receives signals through the baseband processing unit 6-20 and the RF processing unit 6-10 or through the backhaul communication unit 6-30. The controller 6-50 records and reads data in the storage unit 6-40. To this end, the controller 6-50 may include at least one processor.

With the development of wireless communication systems, CHO+CPAC is being discussed, in which a UE moves simultaneously to a target primacy cell (PCell) and to a target primary SCG cell (PSCell) if certain conditions are fulfilled.

In this regard, the network may need to utilize the existing CHO configuration. For example, the network may need to identically configure the target PCell for the CHO+CPAC and the target PCell for the existing CHO. However, such a configuration by the network has a problem in that the same information is redundantly transferred to the UE in the signaling process. For example, each conditional mobility configuration regarding the same target PCell may always require an additional identifier (for example, condReconfig ID). As an example, assuming that the maximum number of configurable condReconfig IDs is 8, the network may configure only a maximum of 4 (which is half the assumed number) candidate PCells for the UE. The data size of the conditional reconfiguration field regarding the same target PCell may increase. In addition, in terms of inter-node signaling between base stations, signaling for CHO preparation and signaling for CHO+CPAC preparation may overlap.

Accordingly, disclosed herein are operations of a UE and a base station if only the CHO condition is fulfilled when the UE evaluates CHO+CPAC conditions to solve the above-referenced problem of overlapping signaling. Disclosed herein are operations of a UE and a base station for solving a problem which may occur when the network require the UE to perform both a first conditional reconfiguration (for example, CHO) operation and a second conditional reconfiguration (for example, CHO+CPAC) operation (for example, in when a CPAC condition is fulfilled, and when a CHO condition associated with the CPAC condition is also fulfilled, which is to be performed by the UE between CHO and CHO+CPAC operations).

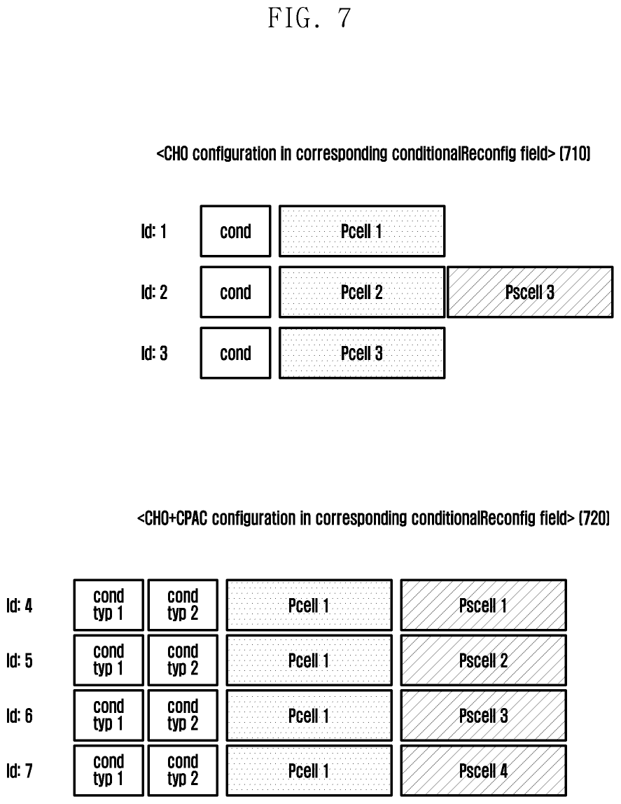

FIG. 7 illustrates an example of a CHO configuration and a CHO+CPAC configuration according to an embodiment.

Referring to FIG. 7, it is assumed that the CHO configuration and the CHO+CPAC configuration are stored in the same UE variable. In this case, different identifiers (for example, condReconfig IDs) may be associated with respective configurations to distinguish the configurations from each other. Alternatively, if the CHO configuration and the CHO+CPAC configuration are separately indicated, respective configurations of different types may be stored in different UE variables. In this case, the condReconfig ID may be unique in each variable, but the condReconfig ID may overlap between variables.

Referring to FIG. 7, in the case of the CHO configuration 710, with regard to condReconfig ID 1, 2, and 3, condition information for a target PCell and/or configuration information of the target PCell may be associated with each ID. Each target PCell's configuration information may include a specific target PSCell's configuration information or may be associated therewith. For example, in the case of ID 1 and 3, only target PCell information exists, but ID 2 may be associated with configuration information of target PCell 2 and target PSCell 3 together. Such a configuration may follow network implementation. As used herein, a CHO condition may refer to a condition to perform a CHO to a target PCell associated with a specific CHO configuration.

In the case of the CHO+CPAC configuration 720, condReconfig ID 4 to 7 may be assigned, and each ID may be associated with at least one of a condition for a target PCell (for example, condition type 1), a condition for a target PSCell (for example, condition type 2), a target PCell configuration, and a target PSCell configuration. For example, in the case of CHO+CPAC, condition type 1 and condition type 2 may always need to be configured, and the target PCell configuration and the target PSCell configuration may, likewise, always need to exist. In relation to CHO+CPAC, a CHO condition may refer to a condition type 1 to a target PCell associated with a specific CHO+CPAC configuration. A CPAC condition may refer to a condition type 2 to a target PSCell associated with a specific CHO+CPAC configuration.

Herein, it may be considered that only a CHO+CPAC configuration exists in the UE, or if a CHO+CPAC configuration and a CHO configuration are simultaneously given to the UE, a specific condition for CHO and a specific CHO condition (condition type 1) for CHO+CPAC are fulfilled simultaneously, and the network then determines and configures the UE such that the UE performs CHO+CPAC by applying the CHO+CPAC configuration which has the CHO condition type 1.

The UE may perform CHO+CPAC if, in the above scenarios, any CPAC condition associated with the CHO+CPAC configuration has not been fulfilled, and a specific CHO condition has been fulfilled. The UE may then operate as follows:

If there is one CHO+CPAC configuration associated with the fulfilled CHO condition, the UE may apply the CHO+CPAC configuration associated with the fulfilled CHO condition.

The UE may then apply the entire CHO+CPAC configuration. Alternatively, the UE may apply only the remaining part of the CHO+CPAC configuration other than the SCG configuration part.

If there are multiple CHO+CPAC configurations associated with the fulfilled CHO condition, and if conditions regarding multiple target PCells (or multiple candidate target PCells, which hereinafter will be used interchangeably) are fulfilled, the UE may first select a specific target PCell regarding which a CHO is to be performed according to the CHO+CPAC configuration, among the multiple target PCells, based on at least one of arbitrarily selecting according to UE implementation, selecting a PCell having the best received signal strength among the target PCells, selecting a PCell having a maximum number of beams over threshold among the target PCells, and selecting a PCell having the best average of beams which is over the threshold among the target PCells.

Thereafter, if there are still multiple CHO+CPAC configurations associated with the CHO condition fulfilled with regard to the selected target PCell (for example, if multiple PSCells exist with regard to the same target PCell), the UE may additionally perform an operation of selecting a specific target PSCell regarding which a CPAC is to be performed among multiple target or candidate target PSCells.

If fulfilled CHO conditions have the same target PCell, and there are multiple target PSCells associated with the target PCell, the UE may select a specific target PSCell regarding which a CPAC is to be performed among multiple target PSCells. For example, as a method for selecting a specific target PSCell among CHO+CPAC configurations having the same target PCell, the UE may arbitrarily select a PSCell, the network may configure specific PSCell information, a corresponding PSCell may be selected, a PSCell with a best signal may be selected, or S-criteria may be considered in the selection.

Specifically, the UE arbitrarily selects a PSCell according to UE implementation.

The master node (MN) may configure, for the UE, specific PSCell information to be selected by the UE in a case as described above. The PSCell information may include at least one of the following: The identifier (for example, physical cell ID (PCI) and/or frequency (for example, absolute radio frequency channel number (ARFCN) value) information of the PSCell to be selected, the condReconfig ID information of CHO+CPAC including the PSCell to be selected, and select, from a list of conditional reconfigurations, the PSCell of a CHO+CPAC configuration having a condReconfig ID which is the smallest value, the largest value, the first entry of the list, or the last entry of the list. In this case, the network may configure priority when assigning an ID to the CHO+CPAC configuration of the corresponding PSCell.

The corresponding PSCell is selected on the current UE's dual connection exists among the multiple target PSCells.

A PSCell having the best radio signal among the multiple target PSCells may be selected, such as by selecting a PSCell having the best received signal strength among the target PSCells, selecting a PSCell having a maximum number of beams over threshold among the target PSCells, and selecting a PSCell having the best average of beams which is over the threshold among the target PSCells.

The S-criteria is considered by the UE selecting a PSCell fulfilling S-criteria among the multiple target PSCells.

The foregoing operations may be successively or selectively combined and applied. For example, if the current PSCell is not included in multiple PSCells fulfilling the above condition, the UE may select a PSCell having the best received signal strength.

The UE may consider a CHO+CPAC configuration having a combination of a target PCell and a target PSCell selected as described above as the target to be applied by the UE. The UE may apply part or all of the CHO+CPAC configuration.

The UE may apply the entire CHO+CPAC configuration. For example, the UE may apply the RRCReconfiguration message included in the condRRCReconfig field in conditionalReconfiguration.

The UE may apply a part of the CHO+CPAC configuration other than the SCG configuration.

The UE may apply a part of the CHO+CPAC configuration indicated by a PCell and/or a PSCell and/or the entire CHO+CPAC configuration's reference configuration.

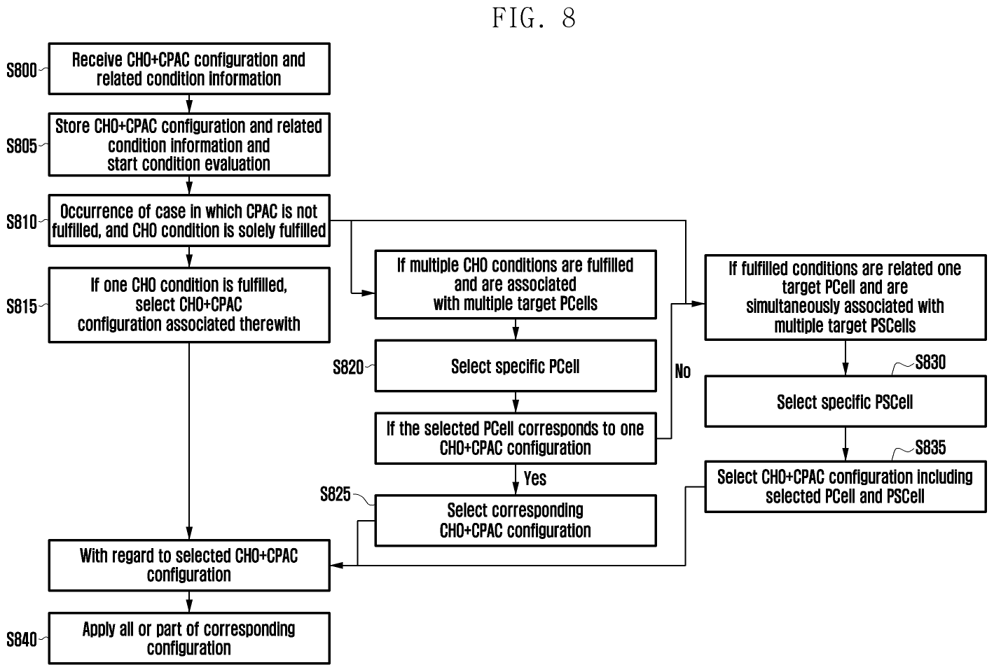

FIG. 8 is a flowchart illustrating operations of a UE according to an embodiment.

In step S800, the UE may receive a CHO+CPAC configuration and related condition information from the base station.

In step S805, the UE may store the received information and may perform condition evaluation together with measurement.

In step S810, the UE may identify the occurrence of when a CPAC-related condition is not fulfilled, but CHO condition(s) are solely fulfilled.

In step S815, if one CHO condition is fulfilled, the UE may select a CHO+CPAC configuration associated with the CHO condition.

If multiple CHO conditions are fulfilled and are associated with multiple target PCells, respectively, the UE may select a specific target PCell (in this case, at least one of the above-described target PCell selection methods may be applied) in step S820. If the selected target PCell corresponds to one CHO+CPAC configuration, the UE may select the one CHO+CPAC configuration in step S825.

If, after a specific target PCell is selected as above, the selected target PCell corresponds to multiple CHO+CPAC configurations, the UE may additionally select a specific target PSCell (in this case, at least one of the above-described target PCell selection methods may be applied) in step S830. The UE may select a CHO+CPAC configuration having a combination of the selected target PCell and target PSCell in step S835.

If fulfilled CHO conditions are related to one target PCell and are simultaneously associated with multiple target PSCells, the UE may perform an operation for selecting a specific target PSCell as described above in step S830. The UE may select a CHO+CPAC configuration having a combination of the selected target PCell and target PSCell as in step S835.

With regard to a CHO+CPAC configuration selected through the above operations, the UE may apply all or part of the CHO+CPAC configuration in step S840, thereby executing a CHO+CPAC.

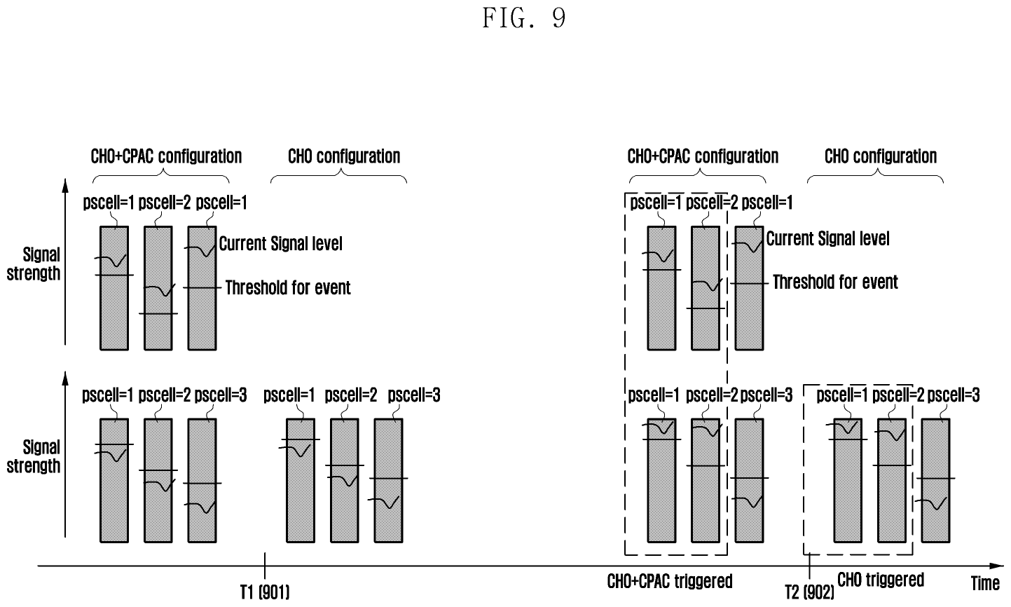

FIG. 9 illustrates an example of a CHO configuration and a CHO+CPAC configuration of each time interval according to an embodiment.

It is assumed that the UE is solely provided with a CHO configuration or is simultaneously provided with a CHO+CPAC configuration.

Referring to FIG. 9, there is no fulfilled condition for PCells among conditions of the CHO+CPAC configuration when conditions for PSCells 1, 2, and 3 are already fulfilled among conditions of the CHO+CPAC configuration at a specific time T1 (901). At the same time T1 (901), there are likewise no fulfilled conditions for PCells among conditions of the CHO configuration. The network may identically configure a condition regarding the same target PCell with regard to either the CHO or the CHO+CPAC. In such a case, the CHO and the CHO+CPAC may not be performed at time T1 (901).

Thereafter, at a specific time T2 (902), some of the conditions of the PCells may be fulfilled when conditions regarding the PSCells of the CHO+CPAC configuration are still fulfilled. In this case, conditions regarding (PCell 1, PSCell 1) and (PCell 2, PSCell 2) of the CHO+CPAC configuration may be fulfilled, and conditions regarding PCell 1 and PCell 2 of the CHO configuration may be simultaneously fulfilled. Therefore, it is necessary to define a method for the UE to select one of combinations of a PCell and a PSCell triggered in the CHO+CPAC configuration, and/or to select one of PCells triggered in the CHO configuration.

In the above-described scenario, the UE may perform an operation according to at least one of the following options.

Opt 1. The UE may preferentially perform a CHO+CPAC.

If a condition associated with a target PCell of a CHO is fulfilled, the UE may determine whether the same target PCell exists among the CHO+CPAC configuration, whether a condition regarding the target PCell is fulfilled, and/or whether a condition of a target PSCell of the CHO+CPAC configuration associated with the target PCell, whose condition has been fulfilled, is fulfilled. If both conditions regarding the target PCell and target PSCell in the CHO+CPAC configuration are fulfilled, the UE may perform a CHO+CPAC without performing a CHO.

To distinguish the target PCell and target PSCell of the CHO+CPAC configuration, the UE may consider at least one of the following as a criterion for determination.

If a condition for the target PCell and a condition for the target PSCell are associated and both are configured in condRRCReconfig corresponding to condReconfig ID stored in a UE variable, the UE may consider that the target PCell and the target PSCell are related to the CHO+CPAC configuration.

As to condRRCReconfig corresponding to all condReconfig IDs stored in a UE variable dedicated to CHO+CPAC, the UE may consider that the target PCell and the target PSCell are related to the CHO+CPAC configuration.

As to condRRCReconfig of condReconfig ID in the ID set used for CHO+CPAC among condReconfig IDs stored in a UE variable, the UE may consider that the target PCell and the target PSCell are related to the CHO+CPAC configuration.

If, among multiple conditional reconfigurations whose conditions are fulfilled simultaneously, condition type 1 and condition type 2 of the CHO+CPAC configuration are both fulfilled, the UE may preferentially apply the CHO+CPAC configuration. Otherwise, the UE may distinguish between CHO configuration and CPAC configuration and apply the CHO configuration or CPAC configuration associated with the fulfilled condition, if each condition is fulfilled.

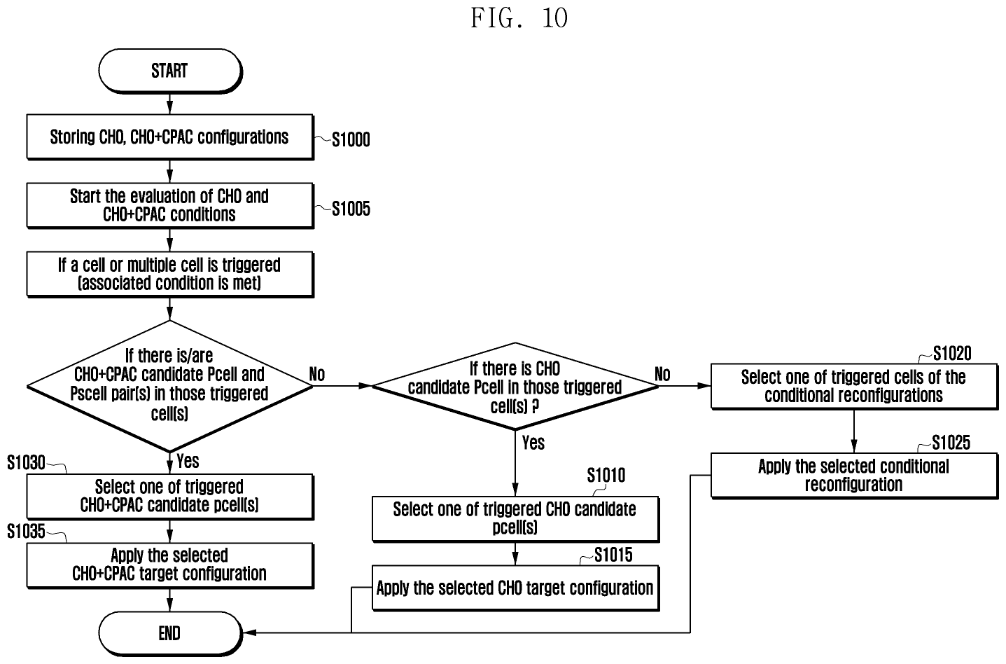

FIG. 10 illustrates operations of a UE in which a CHO+CPAC configuration is applied preferentially according to an embodiment.

Referring to FIG. 10, the UE may receive a conditional Reconfiguration field from the network, and the conditional Reconfiguration field may include a CHO configuration and/or a CHO+CPAC configuration. Upon receiving the configuration, the UE may store each configuration in a UE variable in step S1000. The UE may perform measurement corresponding to conditions included in respective configurations and may perform (start) evaluation regarding whether respective conditions are fulfilled, in step S1005.

If one or multiple conditions are fulfilled while the UE performs evaluation and if, among the fulfilled condition(s), condition(s) for combination(s) or pair(s) of the target PCell and target PSCell associated with the CHO+CPAC configuration are fulfilled, the UE may apply the CHO+CPAC configuration of a target cell pair associated with the CHO+CPAC configuration (if a condition regarding one target cell pair is fulfilled), or may select one target cell pair (if conditions regarding multiple target cell pairs are fulfilled) and may apply the selected CHO+CPAC configuration to move to the selected target cell pair.

When multiple cells are triggered, if there is/are no CHO+CPAC candidate PCell and PScell pairs in those triggered cells, and if there is CHO candidate PCell in those triggered cells, or in other words, if one or more conditional reconfiguration conditions are fulfilled, but there is no fulfilled condition regarding a target cell pair associated with the CHO+CPAC configuration, the UE may select one CHO target cell fulfilling a condition among CHO target cells in step S1010, and the UE may apply the configuration of the selected CHO target cell in step S1015. Alternatively, the UE may select one of candidate target cells of a conditional reconfiguration other than the CHO, which fulfills a condition, in step S1020, and the UE may apply the selected conditional reconfiguration in step S1025.

When multiple cells are triggered, if there is/are CHO+CPAC candidate PCell and PScell pairs in those triggered cells, the UE may additionally select a target PSCell in step S1030, and the UE may select and apply the CHO+CPAC configuration including the corresponding PSCell in a target cell pair in step S1035. The criterion for selecting a target PSCell may be a PSCell having the best received signal strength among target PSCells, a PSCell having the maximum number of beams over threshold among target PSCells, or a PSCell having the best average of beams which is over the threshold among target PSCells.

Opt 2. The UE may preferentially perform a CHO.

To this end, the CHO performing operation among the UE's existing operations may be maintained as it is, but there is a need to limit trigger of the operation in which the UE determines whether to apply the CHO+CPAC configuration having a condition fulfilled together.

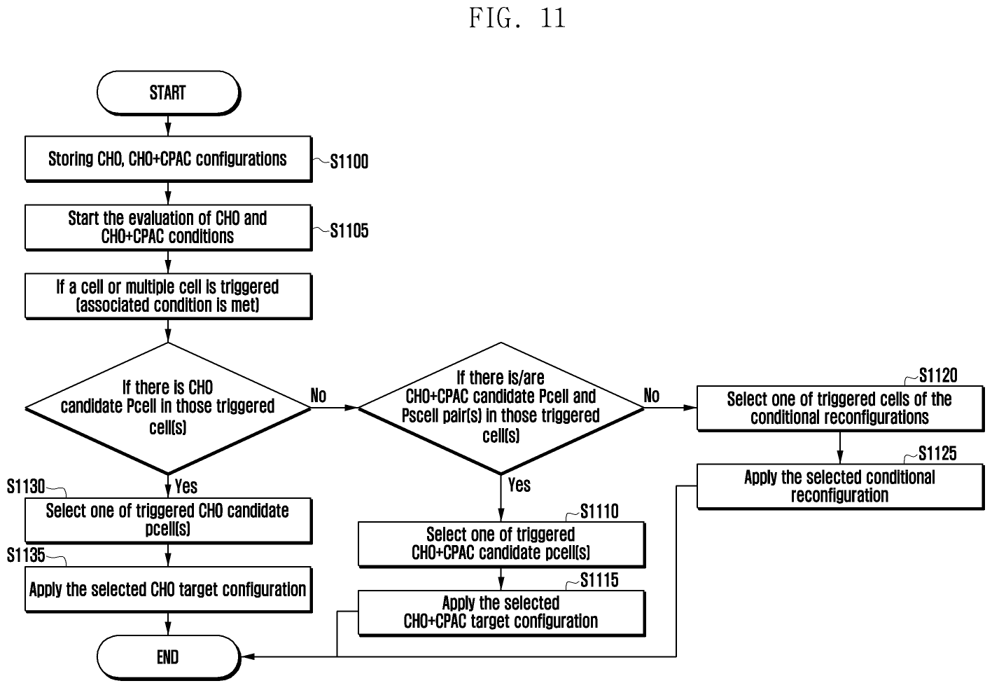

FIG. 11 illustrates operations of a UE in which a CHO configuration is applied preferentially according to an embodiment.

Referring to FIG. 11, the UE may receive a conditional Reconfiguration field from the network, and the conditional Reconfiguration field may include a CHO configuration and/or a CHO+CPAC configuration. Upon receiving the configuration, the UE may store each configuration in a UE variable in step S1100. The UE may perform measurement corresponding to conditions included in respective configurations and may perform (start) evaluation regarding whether respective conditions are fulfilled, in step S1105.

If one or multiple conditions are fulfilled while the UE performs evaluation and, among the fulfilled condition(s), condition(s) of a target PCell associated with the CHO configuration are fulfilled, the UE may apply the CHO configuration of the target PCell associated with the CHO configuration if a condition regarding one target PCell is fulfilled, or may select one target PCell if conditions regarding multiple target PCells are fulfilled, and may apply the selected CHO configuration to move to the selected target PCell.

When multiple cells are triggered, if there is no CHO candidate PCell in those triggered cells, and if there is/are CHO+CPAC candidate PCell and PScell pairs in those triggered cells, or in other words, if one or more conditional reconfiguration conditions are fulfilled, but there is no fulfilled condition regarding a target PCell associated with the CHO configuration, the UE may select one pair fulfilling a condition among CHO+CPAC target cell pairs in step S1110, and the UE may apply the configuration of the selected CHO+CPAC target cell pair in step S1115. Alternatively, the UE may select one of candidate target cells of a conditional reconfiguration other than the CHO+CPAC, which fulfills a condition, in step S1120, and the UE may apply the selected conditional reconfiguration in step S1125.

When multiple cells are triggered, if there is CHO candidate PCell in those triggered cells, the UE may additionally select a target PCell in step S1130, and the UE may select and apply the CHO configuration regarding the corresponding PCell in step S1135. The criterion for selecting the target PSCell may be a PCell having the best received signal strength among target PCells, a PCell having the maximum number of beams over threshold among target PCells, or a PCell having the best average of beams which is over the threshold among target PCells.

Opt 3. The UE may select one target PCell among target PCells through the following criterion, among a CHO configuration and a CHO+CPAC configuration, and may apply the corresponding configuration.

A PCell having the best received signal strength among target PCells, a PCell having the maximum number of beams over threshold among target PCells, or a PCell having the best average of beams which is over the threshold among target PCells, is selected.

If there are multiple CHO+CPAC configurations regarding a target cell pair including the selected target PCell, the UE may additionally determine one CHO+CPAC configuration by using the PSCell selection criterion of Opt 1.

Opt 4. The UE may arbitrarily select a configuration to be applied from multiple CHO configurations and CHO+CPAC configurations having conditions fulfilled according to implementation.

Opt 5. The base station may explicitly signal a configuration to be applied by the UE if conditions of a CHO configuration and a CHO+CPAC configuration are fulfilled simultaneously. For example, the base station may indicate at least one of information (for example, PCI and/or ARFCN) regarding a specific PCell to be applied by the UE, or information (for example, PCI and/or ARFCN) regarding a specific PSCell, or condReconfig ID of a specific configuration to the UE through RRC signaling/MAC CE/DCI.

In respective options described above, if the UE performs a CHO, the UE may apply the corresponding CHO configuration and may delete stored conditional mobility configurations. For example, the UE may delete the stored CHO configuration only, may delete the CHO+CPAC configuration only, or may delete both CHO and CHO+CPAC configurations. The UE may transmit an RRCReconfigurationComplete message to the target PCell for the selected CHO.

Likewise, in respective options described above, if the UE performs a CHO+CPAC, the UE may apply the corresponding CHO+CPAC configuration and may delete stored conditional mobility configurations. For example, the UE may delete only the stored CHO configuration, only the CHO+CPAC configuration, or both of the CHO and CHO+CPAC configurations. The UE may transmit an RRCReconfigurationComplete message to the target PCell for the selected CHO+CPAC.

The RRCReconfigurationComplete message may include at least one of the following pieces of information:

An indicator indicating that the performed operation corresponds to a CHO+CPAC configuration

The ID of a selected CHO+CPAC configuration, such as the condReconfig ID value of a selected CHO+CPAC configuration transferred to the UE

At least one of the ID (for example, PCI and/or ARFCN) of a selected target PCell and the ID (for example, PCI and/or ARFCN) of a selected target PSCell

The cell global ID (CGI) or gNB ID of a target secondary node (SN) operating the selected target PSCell

An SN RRCReconfigurationComplete message for informing the target SN that the CHO+CPAC has been performed completely

The SN RRCReconfigurationComplete message may include some of the above-enumerated pieces of information.

After the RRCReconfigurationComplete is transferred to the target PCell, the target MN which operates the target PCell may recognize that the UE has performed a CHO+CPAC and may transmit the SN RRCReconfigurationComplete message to inform the target SN which operates the selected target PSCell that the CHO+CPAC has been performed completely, through information (for example, ID of the target PSCell) included in the RRCReconfigurationComplete message. The target SN may recognize the target PSCell from the information included in the message. The target MN may transmit a message to inform the source MN of a successful handover to the target MN. The message may be a handover success message transmitted through an Xn interface. The message may include the UE's ID and/or an indicator indicating whether the successful handover is a CHO or a CHO+CPAC.

When the network provides configuration information to the UE such that a CHO configuration and a CHO+CPAC configuration coexist as described above, existing CHO configuration information may include not only a PCell configuration, but also a PSCell configuration. For example, the CHO configuration may include a configuration of PCell 1+PSCell 1. The CHO+CPAC configuration information may include a configuration of PCell 1+PSCell 1. In the above case, the content (for example, RRCReconfiguration message) of condRRCReconfig may be identical.

Accordingly, if the CHO's target PCell and the CHO+CPAC's target PCell are identical, and the PCell configuration generated by the network is identical, at least one of the following methods may be applied to reduce the signaling burden.

If respective configurations are to be stored by using the same UE variable, condReconfig ID may be additionally included in an octet string of the existing condRRCReconfig field. If CHO configuration or CHO+CPAC configuration corresponding to the condRRCReconfig is included in an octet string as in existing approaches, and the condReconfig ID exists additionally, the UE may be aware that the corresponding ID is related to each CHO+CPAC configuration or CHO configuration, and the configuration regarding the corresponding target PCell and/or target PSCell is identical to the configuration included in the octet string.

If respective configurations are to be stored by using the same UE variable, different condReconfig IDs having the same PCell configuration may be introduced in the condRRCReconfig field. In this case, each piece of condition information may also be associated with condReconfig ID and included in a list.

If the CHO configuration and the CHO+CPAC configuration are stored in different UE variables, the condRRCReconfig of one variable may additionally include an octet string and a condReconfig ID. The UE may refer to the condReconfig ID of the other variable with regard to the condReconfig ID.

As to the CHO configuration and the CHO+CPAC configuration, the same condRRCReconfig as in existing approaches may be repeatedly used.

Herein, each block and combinations of blocks in the flowchart illustrations can be implemented by computer program instructions provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). Alternatively, the functions noted in the blocks may occur out of order. For example, two blocks shown in succession may in fact be executed substantially concurrently or the blocks may sometimes be executed in the reverse order, depending upon the functionality involved.

Herein, a unit refers to a software element or a hardware element, such as a field programmable gate array (FPGA) or an application specific integrated circuit (ASIC), which performs a predetermined function. However, the unit does not always have a meaning limited to software or hardware. The unit may be constructed either to be stored in an addressable storage medium or to execute one or more processors. Therefore, the unit includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the unit may be either combined into a smaller number of elements, or a unit, or divided into a larger number of elements, or a unit. Moreover, the elements and units may be implemented to reproduce one or more CPUs within a device or a security multimedia card. Furthermore, the unit in embodiments may include one or more processors.

Methods herein may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure.

These programs (software modules or software) may be stored in non-volatile memories including a random access memory (RAM) and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

The programs may be stored in an attachable storage device which can access the electronic device through communication networks such as the Internet, Intranet, LAN, Wide LAN (WLAN), and storage area network (SAN) or a combination thereof. Such a storage device may access the electronic device via an external port. A separate storage device on the communication network may access a portable electronic device.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a terminal in a wireless communication system, the method comprising:
obtaining a first type of conditional reconfiguration and a second type of conditional reconfiguration;
identifying whether at least one condition associated with the first type of conditional reconfiguration and the second type of conditional reconfiguration is fulfilled, wherein:
in case that a condition for a primary cell (PCell) associated with the first type of conditional reconfiguration is fulfilled, the PCell associated with the first type of conditional reconfiguration is identified as a triggered cell, and
in case that conditions for a PCell and a primary secondary cell group cell (PSCell) associated with the second type of conditional reconfiguration are fulfilled, the PCell and the PSCell associated with the second type of conditional reconfiguration are identified as a pair of triggered cells;
identifying whether one or more pairs of triggered cells exist;
in case that the one or more pairs of triggered cells do not exist, identifying whether one or more triggered cells exist; and
in case that the one or more triggered cells exist, applying the first type of conditional reconfiguration.

2. The method of claim 1, further comprising:
in case that the one or more pairs of triggered cells exist, applying the second type of conditional reconfiguration.

3. The method of claim 1, further comprising:
in case that multiple pairs of triggered cells exist, selecting one of the multiple pairs of triggered cells and applying the second type of conditional reconfiguration.

4. The method of claim 1,
wherein the first type of conditional reconfiguration and the second type of conditional reconfiguration are associated with different conditional reconfiguration identifiers, respectively.

5. The method of claim 2, further comprising transmitting a radio resource control (RRC) reconfiguration complete message including an absolute radio frequency channel number value and a physical cell identifier of the PSCell associated with the second type of conditional reconfiguration.

6. A terminal in a wireless communication system, the terminal comprising:
a transceiver; and
a controller coupled with the transceiver and configured to:
obtain a first type of conditional reconfiguration and a second type of conditional reconfiguration,
identify whether at least one condition associated with the first type of conditional reconfiguration and the second type of conditional reconfiguration is fulfilled, wherein:
in case that a condition for a primary cell (PCell) associated with the first type of conditional reconfiguration is fulfilled, the PCell associated with the first type of conditional reconfiguration is identified as a triggered cell, and
in case that conditions for a PCell and a primary secondary cell group cell (PSCell) associated with the second type of conditional reconfiguration are fulfilled, the PCell and the PSCell associated with the second type of conditional reconfiguration are identified as a pair of triggered cells,
identify whether one or more pairs of triggered cells exist,
in case that the one or more pairs of triggered cells do not exist, identify whether one or more triggered cells exist, and
in case that the one or more triggered cells exist, apply the first type of conditional reconfiguration.

7. The terminal of claim 6, wherein the controller is further configured to:
in case that the one or more pairs of triggered cells exist, applying the second type of conditional reconfiguration.

8. The terminal of claim 6, wherein the controller is further configured to:
in case that multiple pairs of triggered cells exist, selecting one of the multiple pairs of triggered cells and applying the second type of conditional reconfiguration.

9. The terminal of claim 6, wherein the first type of conditional reconfiguration and the second type of conditional reconfiguration are associated with different conditional reconfiguration identifiers, respectively.

10. The terminal of claim 7, wherein the controller is further configured to transmit, via the transceiver, a radio resource control (RRC) reconfiguration complete message including an absolute radio frequency channel number value and a physical cell identifier of the PSCell associated with the second type of conditional reconfiguration.
